(19) United States
(12) Patent Application Publication
(10) Pub. No.: US 2004/0120866 A1
(43) Pub. Date: Jun. 24, 2004

(54) Method and installation for regenerating absorbents used for capturing sulphur dioxide in combustion fumes

(76) Inventors: Gerard Martin, Saint Genis Laval (FR); Etienne Lebas, Seyssuel (FR)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/475,661

(22) PCT Filed: Apr. 22, 2002
(86) PCT No.: PCT/FR02/01380

(30) Foreign Application Priority Data
Apr. 27, 2001 (FR) 0105842

(51) Int. Cl. B01J 38/04; B01D 53/96

(52) U.S. Cl. 422/178; 502/34; 422/173; 422/225

(57) ABSTRACT

The invention relates to a method for regenerating a used solid absorbent from a desulphurization zone wherein partial combustion of a regenerating gas, regeneration of the absorbent by contacting, in a chamber, said absorbent with the gas effluents derived from the combustion, cooling the gas mixture resulting from regeneration to a temperature higher than the liquid sulphur formation temperature, and filtering the cooled mixture to separate the solid particles of regenerated absorbent from the gas fraction of said mixture is carried out. The invention also relates to an installation for implementing said method.

### FIELD OF THE INVENTION

The present invention relates to the field of combustion and more particularly of regeneration of sulphur oxide absorbents used to process, by capturing said sulphur oxides, fumes coming for example from a combustion means for combustion of a fuel containing sulphur.

In general, said fumes derive from thermal power plants, industrial furnaces and boilers.

The present invention can also be applied for example to effluents from various chemical or refining processes, sulphuric acid production shops, ore calcining plants, catalytic cracking plants.

### BACKGROUND OF THE INVENTION

Many installations intended for fumes desulphurization are already known.

French patent FR-2,636,720 notably discloses a boiler wherein desulphurizing agents are injected into a specific chamber referred to as desulphurization chamber, intercalated between the combustion chamber and the convective-exchange heat recovery zone. The desulphurizing agents provided in this installation are preferably non-regeneratable calcic absorbents such as limes or limestones, or industrial residues with a high calcium carbonate content (sugar factory scum, paper mill scum).

Various improvements have been made to this type of boilers in order to increase the output thereof while having a high efficiency as regards trapping of sulphur oxides notably.

An improvement illustrated in French patent FR-2,671,855 consisted in using absorbents referred to as <<regeneratable>> absorbents, which are regenerated in a device arranged downstream from the boiler, after the final dust separator. This improvement, which keeps the advantages of installations using non regeneratable absorbents, notably as regards desulphurization, furthermore allows to limit very appreciably the amounts of used absorbent to be dumped, which is favourable to the quality of the environment. Besides, the marked decrease in the amounts of used absorbent to be eliminated allows to envisage inerting treatments and/or storage in technical burial centers at non prohibitive costs.

A different embodiment, illustrated by French patent FR-2,730,424, provides regeneration at the same time as filtration of the used absorbent, in a single reactor.

The methods described above use as the regeneration gas a hydrogen or hydrocarbon containing compound having a total carbon number below 10, such as hydrogen, methane, ethane, propane, isobutane and/or a mixture of said gases. Hydrogen is the most suitable regeneration gas because it does not lead to coking of the absorbent. However, supplying it to the industrial site, a refinery for example, can pose problems. In fact, hydrogen is not always available in sufficient amounts in refineries, in particular when many conversion and/or hydrotreating operations are to be carried out.

Furthermore, costly specific equipments linked with the use of hydrogen during the regeneration stage are necessary for implementing the aforementioned two methods.

Patent application FR-00/07,121 filed by the applicant describes the use of hydrogen sulfide for regeneration of the desulphurization absorbent before the regeneration-filtering stage. This solution may however lead to considerable corrosion problems because of the high reducing regeneration gas concentrations, and because of the high temperatures required for regeneration (between about 600° C. and about 800° C.). Under such conditions, the filtering elements used will necessarily have a limited lifetime.

### SUMMARY OF THE INVENTION

The present invention allows to overcome some of the drawbacks encountered in prior installations, notably linked with the corrosion at high temperatures of the filtering and/or regeneration elements by hydrogen sulfide.

The present invention thus relates to a method of regenerating a used solid absorbent from a desulphurization zone comprising the following stages:

a) partial combustion of a regeneration gas,

b) regeneration of the absorbent by contacting, in a chamber, said absorbent with the gaseous effluents from stage a),

c) cooling the gaseous mixture from stage b) to a temperature higher than the liquid sulphur formation temperature,

d) filtering the cooled mixture so as to separate the solid particles of regenerated absorbent from the gas fraction of said mixture.

This method additionally comprises the following stages:

e) cooling the gas fraction from stage d) to a temperature lower than the sulphur liquefaction temperature,

f) separation of the liquid sulphur and of the gaseous effluent resulting from said cooling stage.

Advantageously, the gaseous effluents from stage a) are mixed with the used absorbent prior to the regeneration stage.

Advantageously, the gaseous effluents from stage a) are mixed with the used absorbent during the regeneration stage.

In general, the gaseous effluent from stage f) is sent to the catalytic stages of a Claus chain.

Said regeneration gas preferably comprises hydrogen sulfide.

According to an embodiment, the gaseous effluents from combustion stage a) are partly cooled.

The regenerated absorbent obtained after the regeneration stage and the filtering stage is sent to a storage unit.

By way of example, the regenerated absorbent is mixed with a carrier gas, then sent to said desulphurization zone.

Alternatively, a regeneration catalyst is mixed with the used absorbent.

The invention also relates to an installation intended for regeneration of a used solid absorbent coming from a thermal desulphurization zone and comprising:

means for partial combustion of a regeneration gas,

regeneration means including delivery means for the gaseous effluents from said combustion means and delivery means for the used absorbent,

discharge means for the regenerated absorbent and discharge means for the gaseous mixture from the regeneration stage,

means for cooling said gaseous mixture to a temperature higher than the sulphur liquefaction temperature,

means for filtering the cooled mixture, including discharge means for the gas fraction of said mixture and discharge means for the solid particles of regenerated absorbent.

This installation can comprise:

means for cooling the gas fraction coming from the filtering means to a temperature lower than the sulphur liquefaction temperature and means for separating the liquid sulphur and the gaseous effluent resulting from said cooling stage.

According to a preferred embodiment, the installation can comprise, between the combustion means and the regeneration means, a means intended for partial cooling of the gaseous effluents coming from said combustion means.

The cooling means can include gaseous effluent discharge means connected to an inlet of a Claus plant.

The regeneration device can comprise a chamber innerly coated with a heat-resisting and non-corrodible material.

This chamber can comprise a cooling means.

The regeneration device comprises a stirring means allowing to suspend at least part of the solid particles of the absorbent in the gas phase.

By way of example, this stirring means can consist of paddles carried by a shaft.

By means of the invention, the device provided can be readily integrated in a Claus chain by simple addition of a regeneration device and of a filtering means. A certain number of equipments existing in said chain, such as the furnaces and burners of the thermal stage(s), the heat recuperators, the condensers, the catalytic conversion stages of the Claus chain can therefore be advantageously used for implementing the present method and/or installation.

Furthermore, in relation to techniques of the prior art, this regeneration mode avoids having gases with high solids contents outside the regeneration device, and it prevents the fouling and clogging risks that may arise, and consequently a decrease in the exchange coefficients in the heat recovery means used.

The regeneration device according to the invention is simple, robust and minimizes contacts of the regeneration gas with the metallic surfaces of the various elements that constitute the high-temperature regeneration and filtering chain. Corrosion and clogging risks are also limited.

The present invention also allows, through the combined effects of a partial combustion of the regeneration gas prior to said regeneration and of the proximity of the heating means and of the regeneration zone, to limit handling and transportation of the corrosive fumes containing, for example, hydrogen sulfide. It also allows to use a regeneration gas that is readily available on the site.

Besides, no recycling of the regeneration gas is necessary so that all of the physical devices linked with said recycling can be removed.

### BRIEF DESCRIPTION OF THE FIGURES

Other features and advantages of the device according to the invention will be clear from reading the description hereafter, given by way of non limitative example, with reference to the accompanying drawings wherein:

FIG. 1 is a diagrammatic view of an installation according to the invention,

FIG. 2 illustrates an embodiment of the regeneration device described in connection with FIG. 1.

### DETAILED DESCRIPTION

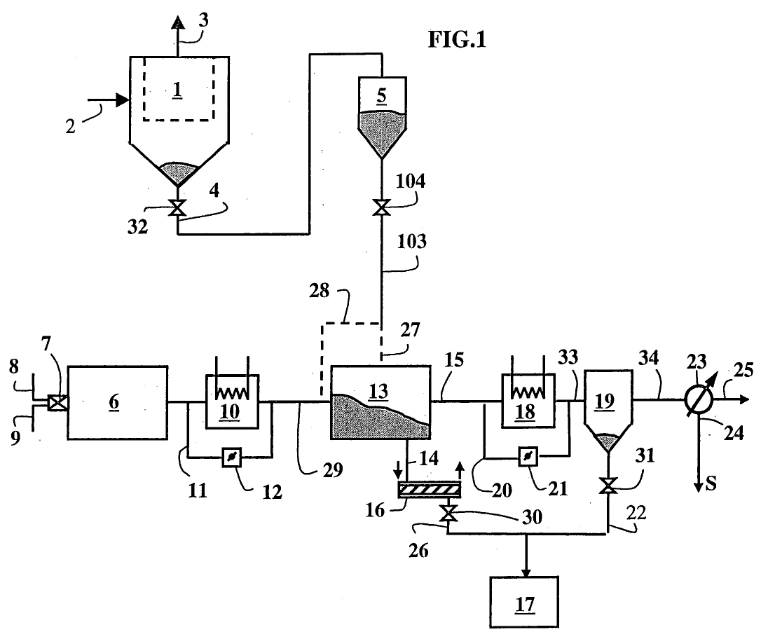

FIG. 1 diagrammatically shows an embodiment of the invention wherein fumes coming from a thermal generator (not shown) are treated by a regeneratable absorbent such as a magnesian absorbent as formulated for example in patent FR-2,692,813.

These fumes flow through line 2 into a filter 1 such as a bag filter or an electrostatic filter or any other equivalent device. The fumes freed of the used regeneratable absorbent and of the dust are discharged through the stack by means of line 3, whereas said used regeneratable absorbent is discharged through line 4, then sent to an intermediate storage device 5, and transportation through connecting line 4 can be advantageously carried out under pneumatic conditions with oxygen-poor or oxygen-free gas.

The absorbent is then sent to a chain comprising a furnace 6 equipped with one or more burners 7 which partially burn, under lack of oxygen, a H₂S (hydrogen sulfide)-rich gas supplied through line 8. The oxidizer, which may be air or an oxygen-enriched gas, is fed through line 9. The gaeous effluents from furnace 6 contain, among other things, hydrogen and hydrogen sulfide. Their temperature generally ranges between 1000 and 1500° C. according to optimized operating conditions.

These gaseous effluents are partly cooled in a cooling device 10, an exchanger for example. This device is equipped with a temperature control means such as, for example, a bypass line 11 provided with a valve 12, preferably cooled, which may be a simple shutter. This control means is dimensioned and/or controlled so as to maintain the temperature of the gaseous effluents at the inlet of an absorbent regeneration device 13 between about 600° C. and about 900° C., preferably between about 700° C. and about 800° C., whatever the working conditions of furnace 6 upstream.

Regeneration device 13 is designed so as to prevent contact of the gaseous effluents with metallic parts at high temperatures, i.e. above 350° C. This protection of the metallic parts from the high-temperature gaseous effluents can be obtained, for example, by cooling said metallic parts by means of an inner circulation of a cold fluid and/or by insulating said parts by means of a heat-resisting ceramic material layer, refractory concrete for example.

The absorbent to be regenerated and the gaseous regeneration effluents are introduced at one end of the device, and the regenerated absorbent and the gaseous mixture resulting from the regeneration stage leave the device at another end, through lines 14 and 15 respectively.

Without departing from the scope of the invention, the absorbent to be regenerated coming from storage zone 5 and circulating through line 103 can be fed either through a line 27 into device 13 so as to be mixed with the gaseous effluents in this device, or through a line 28 into pipe 29, downstream from said device 13 in relation to the direction of circulation of the hot gaseous mixture, so as to be mixed with these gaseous effluents prior to being fed into said device.

The regenerated absorbent can be sent to a cooling device 16 such as, for example, a cooled screw inside which a cooling fluid flows as shown by arrows in FIG. 1, then to a storage chamber 17 through a line 26. The gaseous mixture from regeneration device 13 is sent to a cooling means 18 through line 15 so as not to exceed a temperature ranging between 200 and 400° C., preferably 350° C., then it passes, via a connection 33, into a filtering device 19, advantageously of electrostatic filter type, operated at a temperature higher than the liquid sulphur formation temperature under the pressure conditions prevailing in said device 19, so that the sulphur is in the gas phase. Cooling means 18 can be equipped with a gaseous mixture temperature control means such as, for example, a bypass line 20 provided with a valve 21 in order to maintain said temperature substantially constant at the inlet of filtering device 19, whatever the working conditions upstream Said inlet temperature is determined so as to, on the one hand, minimize corrosion problems and, on the other hand, to prevent liquefaction of the sulphur in device 19. The absorbent collected at the level of filtering device 19 is sent to storage chamber 17 through line 22. The absorbent can then be mixed with a carrier gas and sent to a combustion fumes processing zone (not shown) downstream from element 1. The gas fraction resulting from the filtering stage then passes through a line 34 into a condenser 23 which brings the temperature of this gas fraction to a value ranging between about 100° C. and about 200° C., and allows to recover elementary sulphur in liquid form. The sulphur is discharged through line 24 and the gaseous effluent cooled through line 25 is sent to the catalytic stages of a Claus chain (not shown in FIG. 1).

Valves 30, 31, 32, 104 distributed in the installation described above in connection with FIG. 1 allow to control the flows of solid particles between the various elements that constitute said installation.

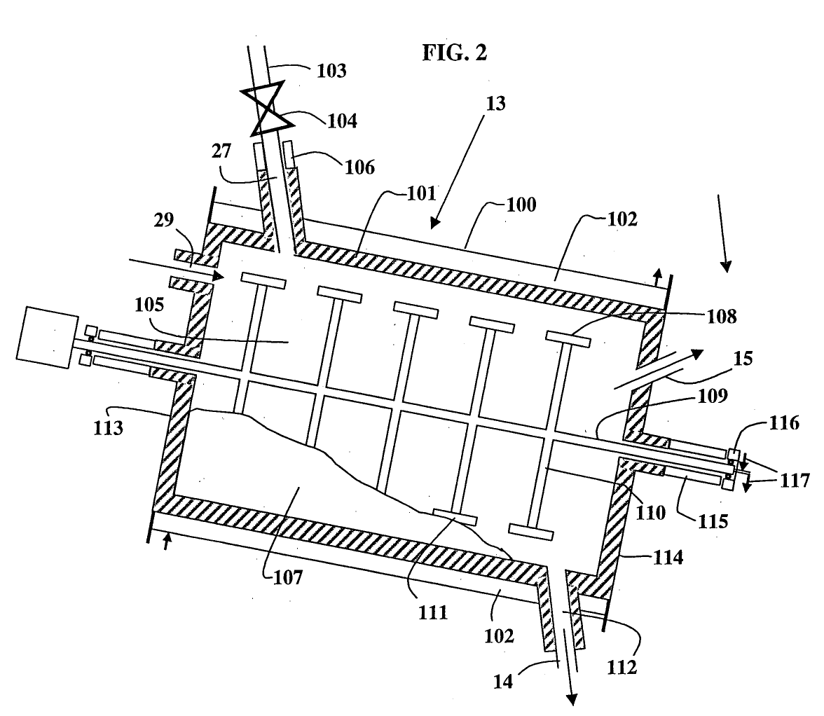

FIG. 2 is a non limitative illustration of an embodiment of absorbent regeneration device 13 shown in FIG. 1. This device consists of a substantially cylindrical metallic chamber 101 innerly coated with a layer 101 of a heat-resisting and non corrodible material such as refractory concrete and delimiting a reaction zone 105. Said metallic chamber can be partly or totally cooled by a water jacket 102 so as to avoid any risk of corrosion that might appear in case of local breakage of insulating refractory material layer 101.

The absorbent is conveyed through line 103 and a valve 104, preferably cooled, is arranged on said line 103 to control and regulate the absorbent flow rate. This valve also provides atmosphere insulation between absorbent storage zone 5 arranged upstream, as shown in FIG. 1, and reaction zone 105 containing the reducing gases such as hydrogen and hydrogen sulfide reputed to be toxic and flammable.

These gases, generated by partial oxidation of a gas essentially consisting of hydrogen sulfide H₂S, flow into regeneration device 13 through line 29, also innerly coated with refractory materials allowing to protect its metallic parts against corrosion.

Valve 104 is connected to metallic chamber 100 by line 27 provided with a cooling device 106 in order to avoid risks of corrosion by the hydrogen sulfide upstream. Injection of a non-corrosive gas such as steam as a scavenging means for line 27 to prevent contact of valve 104 with the corrosive gases of the generator can be provided without departing from the scope of the invention.

In the embodiment described in connection with FIG. 1, the used absorbent is thus contacted with the partly burnt regeneration gas close to the inlet of reaction zone 105. Without departing from the scope of the invention, mixing can also be carried out upstream from said zone, for example in pipe 29 via line 28 shown in FIG. 1.

The absorbent falls, under the effect of gravity, into chamber 105 and forms a layer 107. This layer is stirred by a stirrer 108 which can be cooled by circulation of a fluid such as water.

This stirrer consists of a central shaft 109 and of arms 110 which are provided, at the ends thereof, with paddles or equivalent parts 111. These paddles 111 are intended to provide proper stirring of the solid absorbent particles and to suspend in the gas phase part of the particles of this absorbent in order to favour contacts and chemical reactions between the gas phase and the solid phase of the mixture. They are also used to cause the particles bed to progress in the chamber by means of the slight inclination of the assembly.

In the sense of the present invention, it is understood that said gas phase comprises at most some grams of solid particles per cubic meter of gas, i.e. between about 1 and about 50 g, preferably between about 1 and about 10 g.

The major part of the regenerated solid particles of the absorbent is extracted from the chamber under the effect of the gravity forces through line 112. The gaseous effluents and a minor part of the regenerated solid particles of this absorbent are discharged through line 15 to cooling device 19 (FIG. 1).

Devices (not shown in FIG. 2) such as baffles, cooled or protected by refractory materials, can advantageously be arranged upstream from the gas outlet through line 15 in order to minimize entrainment of the fine particles to said line 15.

The central shaft of the stirrer is supported by support means carried by the front 113 and rear 114 faces of chamber 100. These support means can comprise, for example, bearings, a bearing cooling device 115 and expansion take-up means 116, as well as delivery means 117 supplying the stirrer with cooling fluid.

Without departing from the scope of the invention, the means allowing stirring of the solid particles in reaction zone 105 can consist of any known equivalent means allowing better contact and exchange between said solid particles and the hot gases, in particular a cooled coreless helical screw or a hearth furnace.

The present invention is not limited to the examples described and it includes any variant.

A regeneration catalyst can notably be mixed with the used absorbent. This catalyst can for example comprise at least one noble metal from group VIII of the periodic table, such as platinum or palladium, or a compound comprising at least one element from the rare earths group, preferably cerium or a cerium oxide.

1) A method of regenerating a used solid absorbent from a desulphurization zone, comprising the following stages:
a) partial combustion of a regeneration gas,
b) regeneration of the absorbent by contacting, in a chamber, said absorbent with the gaseous effluents from stage a),
c) cooling the gaseous mixture from stage b) to a temperature higher than the liquid sulphur formation temperature,
d) filtering the cooled mixture so as to separate the solid particles of regenerated absorbent from the gas fraction of said mixture.

2) A method as claimed in claim 1, characterized in that it comprises the following stages:
e) cooling the gas fraction from stage d) to a temperature lower than the sulphur liquefaction temperature,
f) separation of the liquid sulphur and of the gaseous effluent resulting from said cooling stage.

3) A method as claimed in claim 1, characterized in that it comprises a stage wherein the gaseous effluents from stage a) are mixed with the used absorbent prior to regeneration stage c).

4) A method as claimed in claim 1, characterized in that it comprises a stage wherein the gaseous effluents from stage a) are mixed with the used absorbent during regeneration stage c).

5) A method as claimed in claim 2, characterized in that the gaseous effluent from stage f) is sent to the catalytic stages of a Claus chain.

6) A method as claimed in any one of the previous claims, characterized in that said regeneration gas comprises hydrogen sulfide.

7) A method as claimed in any one of the previous claims, characterized in that the gaseous effluents from combustion stage a) are partly cooled.

8) A method as claimed in any one of the previous claims, characterized in that the regenerated absorbent from regeneration stage b) and filtering stage d) is sent to a storage unit.

9) A method as claimed in any one of the previous claims, characterized in that the regenerated absorbent is mixed with a carrier gas, then sent to said desulphurization zone.

10) A method as claimed in any one of the previous claims, characterized in that a regeneration catalyst is mixed with the used absorbent.

11) An installation intended for regeneration of a used solid absorbent from a thermal desulphurization zone, comprising:
means (6, 7, 8, 9) for partial combustion of a regeneration gas,
regeneration means (13) including delivery means (29) for the gaseous effluents from said combustion means and delivery means (27, 28) for the used absorbent,
discharge means (14) for the regenerated absorbent and discharge means (15) for the gaseous mixture from the regeneration stage,
means (18) for cooling said gaseous mixture to a temperature higher than the sulphur liquefaction temperature,
means (19) for filtering the cooled mixture, including discharge means (34) for the gas fraction of said mixture and discharge means (22) for the solid particles of regenerated absorbent.

12) An installation as claimed in claim 11, characterized in that it comprises:
means (23) for cooling the gas fraction coming from the filtering means to a temperature lower than the sulphur liquefaction temperature and means for separating the liquid sulphur and the gaseous effluent resulting from said cooling stage.

13) An installation as claimed in claim 11 or 12, characterized in that it further comprises, between the combustion means and the regeneration means, a means (10) intended for partial cooling of the gaseous effluents coming from said combustion means (6, 7, 8, 9).

14) An installation as claimed in any one of claims 11 to 13, characterized in that cooling means (23) comprises gaseous effluent discharge means (25) which are connected to an inlet of a Claus plant.

15) An installation as claimed in any one of claims 11 to 14, characterized in that regeneration device (13) comprises a chamber (100) innerly coated with a heat-resisting and non corrodible material (101).

16) An installation as claimed in claim 15, characterized in that chamber (100) comprises a cooling means (102).

17) An installation as claimed in any one of claims 11 to 13, characterized in that regeneration device (13) comprises a stirring means (108) allowing to suspend at least part of the solid particles of the absorbent in the gas phase.

18) An installation as claimed in claim 17, characterized in that said stirring means (108) consists of paddles (111) carried by a shaft (109).
